(19) United States
(12) Patent Application Publication
(10) Pub. No.: US 2016/0321477 A1
(43) Pub. Date: Nov. 3, 2016

(54) METHOD FOR COMMUNICATION USING A READER OF PASSIVE RFID TAGS OPERATING IN BACKSCATTERING MODE

(71) Applicant: ORIDAO, Montpellier Cedex 2 (FR)

(72) Inventors: Nicolas REFFE, Lattes (FR); Nicolas DEJEAN, Baillargues (FR)

(21) Appl. No.: 15/027,113

(22) PCT Filed: Oct. 2, 2014
(86) PCT No.: PCT/FR2014/052493

§ 371 Date: Jul. 21, 2016

(30) Foreign Application Priority Data
Oct. 4, 2013 (FR) 1359621

(51) Int. Cl. G06K 7/10; G06F 17/30; H04L 29/06

(52) U.S. Cl. CPC G06K 7/10297; H04L 69/02; G06F 17/30876

(57) ABSTRACT

The communications method comprises the reader and the radio tags communicating via at least one radio interface first protocol comprising at least one protocol layer:
sending (E20) to the radio tags a polling message in compliance with the first protocol and inviting the radio tags that have data for transmitting to a destination entity to make a declaration;
after at least one radio tag has made a declaration, receiving (E50) a message in compliance with the first protocol coming from said radio tag and including data destined for the destination entity and encapsulated using at least one second protocol of a protocol layer higher than the radio interface protocol layer;
extracting (E60) from the message data that has been encapsulated using the second protocol; and
transmitting (E70) the data encapsulated using said at least one second protocol to the destination entity.

### BACKGROUND OF THE INVENTION

The invention belongs to the general field of radio frequency identification (RFID).

The invention relates more particularly to a communications protocol between passive RFID tags operating in backscattering mode and a reader of such tags.

In known manner, radio identification is a technique enabling articles or living beings to be identified and tracked by means of a radio tag also known as an RFID tag. Various types of radio tags exist, depending on whether or not they include a radio-frequency (RF) transmitter, namely:
passive radio tags: such a tag does not incorporate an RF transmitter but operates using a backscattering mode (also referred to as retro-modulation or indeed radio reflection), i.e. it reflects and modulates the wave coming from the reader so as to transmit information thereto (e.g. digital identification). The wave coming from the reader is also used by the passive tag to power the electronic circuit it incorporates, if any;
passive radio tags assisted by a battery or by a local energy harvesting system: such a tag incorporates a power supply that is used for powering the incorporated electronic circuit and/or for improving the RF sensitivity of the radio tag. Nevertheless, it operates in backscattering mode for transmitting information to the reader; and
active radio tags, which incorporate both an RF transmitter and a source of energy powering the transmitter. Communication with the reader then takes place in peer-to-peer mode.

Passive radio tags (whether or not they are assisted by a battery or by a local energy harvesting system) are the tags the most widespread by far in use on the market at present.

In the description below, the terms “passive radio tag” or “passive radio tag operating in backscattering mode” are used broadly to cover passive radio tags regardless of whether or not they are assisted by battery or by a local energy harvesting system.

In the present state of the art, passive radio tags never transmit information spontaneously: on the contrary, they wait to be inventoried by an RFID reader, and then to be interrogated individually thereby.

RFID readers are active devices, transmitting radio frequencies for activating the radio tags that are within radio proximity and supplying them with the energy they need in order to function. The range of communication between the reader and radio tags naturally depends on the frequency band used (e.g. low frequencies (LF) or high frequencies (HF), or indeed ultra high frequencies (UHF)). In addition to sending the tags the energy they need to operate, the reader also sends them specific commands (e.g. read a specific memory address of a radio tag), to which they respond: typically, such a response consists in a radio tag supplying the reader with a digital identifier stored in a dedicated memory address identified in the reader command.

RFID communications protocols between a reader and radio tags thus rely essentially on a radio interface implementing protocols at low-level (levels 1 and 2 of the Open Systems Interconnections (OSI) model). As a result, applications that make use of RFID techniques need to interact directly with the radio interfaces of radio tags, and need to be connected to RFID readers, either directly or else via a telecommunications network (e.g. the public Internet).

Nowadays, progress in RFID technology makes it possible for more and more functions to be available in radio tags, including passive radio tags, such as for example sensor interfaces, monitoring functions, or indeed a microprocessor or a central processing unit (CPU) enabling data to be processed locally and enabling predefined events to be detected. As a result of these improved functions, radio tags have a much larger volume of data for communicating to the applications that use them in comparison with mere digital identification. However, in the present definition of RFID communications protocols, the only way an application can obtain data collected by a radio tag is to know firstly what data to seek, and secondly where to read the data in the radio tag (typically at which memory address), in order to send the appropriate requests to the radio tag by means of the reader.

There therefore exists a need for a method that is more effective and more flexible for enabling applications to obtain such data from passive radio tags, in particular while taking account of the constraints imposed by RFID communications protocols and the fact that these radio tags operate in backscattering mode.

### OBJECT AND SUMMARY OF THE INVENTION

The invention satisfies this requirement in particular by proposing a communications method for performing by a reader of passive radio tags operating in backscattering mode, the reader and the radio tags communicating via at least one radio interface first protocol, the radio interface including at least one protocol layer, the communications method comprising:
a sending step of sending to the radio tags a polling message in compliance with said at least one first protocol, the polling message inviting the radio tags that have data for transmitting to a destination entity to make a declaration;
after at least one radio tag has made a declaration, a reception step of receiving a message in compliance with said at least one first protocol coming from said radio tag, the message including data destined for the destination entity and encapsulated using at least one second protocol of a protocol layer higher than said at least one radio interface protocol layer;
an extraction step of extracting from the message the data that has been encapsulated using said at least one second protocol; and
a transmission step of transmitting the data encapsulated using said at least one second protocol to the destination entity.

The invention also provides a supply method for supplying a radio tag reader with data destined for a destination entity, the supply method being for implementation by a passive radio tag operating in backscattering mode, the radio tag being suitable for communicating with the reader via at least one radio interface first protocol, the radio interface including at least one protocol layer, the supply method comprising:
a reception step of receiving a polling message from the reader, in compliance with said at least one first protocol and inviting the radio tag to declare to the reader whether it has data for transmitting to the destination entity;
if the radio tag makes a declaration to the reader that it has data for transmitting to the destination entity:
   an encapsulating step of encapsulating the data using at least one second protocol of a protocol layer higher than said at least one radio interface protocol layer; and
   a supply step of supplying the reader with a message in compliance with said at least one first protocol and including the data encapsulated using said at least one second protocol.

Correspondingly, the invention also provides a reader of passive radio tags operating in backscattering mode, the reader and the radio tags communicating via at least one radio interface first protocol, the radio interface including at least one protocol layer, said reader comprising:
a sending module for sending to the radio tags a polling message in compliance with said at least one first protocol, the polling message inviting the radio tags that have data for transmitting to a destination entity to make a declaration;
a module that is activated after at least one radio tag has made a declaration, for receiving a message in compliance with said at least one first protocol coming from said radio tag, the message including data destined for the destination entity and encapsulated using at least one second protocol of a protocol layer higher than said at least one radio interface protocol layer;
a module for extracting from the message the data that has been encapsulated using said at least one second protocol; and
a module for transmitting the data encapsulated using said at least one second protocol to the destination entity.

The invention also provides a passive radio tag operating in backscattering mode, suitable for communicating with a radio tag reader via at least one radio interface first protocol, the radio interface including at least one protocol layer, the radio tag comprising:
a module for receiving a polling message from the reader, in compliance with said at least one first protocol and inviting the radio tag to declare to the reader whether it has data for transmitting to a destination entity;
a module that is activated if the radio tag declares to the reader that it has data for transmitting to the destination entity, for encapsulating the data using at least one second protocol of a protocol layer higher than said at least one radio interface protocol layer; and
a module for supplying the reader with a message in compliance with said at least one first protocol and including the data encapsulated using said at least one second protocol.

Thus, the invention proposes making passive radio tags in communication with the reader capable, at their own initiative, of supplying the reader with data that has been collected or processed by the tags (e.g. logs, alarms, pertinent events, etc.) for transmitting to a destination entity, i.e. making them capable of “pushing” the data. In this way, passive radio tags that are operating in backscattering mode and that can communicate only while they are powered (i.e. illuminated) by a reader, are made functionally active. No limitation is associated with the nature of the destination entity, which may vary as a function of the utilisation contexts of the invention. In particular, it may be a software application, a computer system, a server, or even another radio tag, etc., and it may be connected to the radio tag reader either directly or else via a telecommunications network.

For this purpose, the invention relies on three main elements, namely:
at radio tag level, implementing at least one protocol layer of higher order, i.e. above the radio interface used by the radio tag and the reader for communicating with each other. By way of example, such a protocol layer is a transport, network, or application layer of the OSI communications model. This higher protocol layer is used for encapsulating the data that the radio tag seeks to push to the destination entity, the encapsulated data then being transmitted in conventional manner to the reader via the radio interface defined between the reader and the radio tag. Thus, the data may be encapsulated, for example, using an IP network layer protocol and/or at least one transport layer protocol operating above the IP protocol;
at reader level, implementing a polling step, preferably periodically, seeking to detect radio tags that have data for transmission to the destination entity, in order to interrogate them using the radio interface protocol used by the reader and by the radio tag for communicating; and
programming the reader so that it behaves like a simple router on the data supplied by the radio tags and destined for the destination entity: the reader thus acts as a transparent transmission channel for data between the radio tag and the destination entity. It is not necessary for the reader to be capable of interpreting the encapsulated data, and indeed it is recommended that it should be incapable of so doing, in order to preserve security for exchanges between the radio tag and the destination entity (in particular, it is possible to use a secure transport protocol, e.g. such as the datagram transport layer security (DTLS) protocol, for encapsulating the data transmitted to the destination entity). Nevertheless, it should be observed that in a variant, the reader may be configured to process the data before forwarding it to the destination entity.

Thus, by means of the invention, and as a function of the context in which it is to be found (e.g. detecting particular events, collecting a sufficient quantity of data, etc.), it is possible for a radio tag to act proactively to push data to the destination entity, and to do so while complying with the constraints imposed by present-day RFID protocols (in other words the radio interface defined by the protocols, with passive radio tags operating in a backscattering mode). Specifically, unlike the state of the art, the responses from a radio tag are no longer deterministic and solely at the initiative of the reader, but they now depend on the radio tag and on its context (i.e. whether the radio tag decides that data needs to be transmitted to the destination entity). The invention thus provides a new sharing of application intelligence between the radio tag and the destination entity (as contrasted with the state of the art, where such intelligence is shared between the reader and the destination entity).

A radio tag in accordance with the invention thus differs from existing radio tags in that it is capable not only of deciding when to send the data to the destination entity, but also of transmitting this data, if any to the reader, the data being encapsulated using a protocol that can be interpreted by the destination entity, thus enabling exchanges therewith to be made secure. By way of example, this transmission may take place by updating a specific memory address in the radio tag that is provided for this purpose, or else by sending a specific command to the reader. Depending on the selected implementation, the invention makes it possible to rely on existing commands of prior art radio interfaces, or on the contrary it requires new commands to be introduced in such radio interfaces.

In a particular implementation, the communications method includes an inventory-taking step of sending an inventory message inviting the radio tags situated in a radio proximity of the reader to identify themselves with the reader.

This inventory-taking step may take place simultaneously with the polling step. More precisely, the polling message sent by the reader may be included in the inventory message or it may be the same as the inventory message, i.e. it is the inventory message itself as transmitted in compliance with the first protocol that is interpreted by the tags as being an invitation to make a declaration, where appropriate, to the effect that they have data for transmitting, and thus represents in this respect a polling message in the meaning of the invention. This makes it possible to reuse functions that are already provided in certain existing protocols for communication via radio tags, such as the electronic product code (EPC) ultra high frequency (UHF) Gen2 protocol.

In a variant, two distinct messages, one for inventory-taking and the other for polling, may be transmitted at different instants (e.g. beginning with the inventory message and followed by the polling message being sent for example to tags that have been identified in response to the inventory message). In other words, in this variant, a specific message is provided in compliance with the first protocol inviting the radio tags to make a declaration.

In yet another variant, the polling message may make use of an existing command in the first protocol, but while specifying a memory address that is different from that specified in the inventory message.

As mentioned above, the step of sending the polling message is preferably repeated periodically. This ensures that data is returned regularly by the radio tags to the destination entity.

In a particular implementation, the communications method implemented by the reader further includes:
a reception step of receiving from the destination entity a response message destined for the passive radio tag and encapsulated using said at least one second protocol; and
a transmission step of transmitting the response message encapsulated using said at least one second protocol to the passive radio tag in a message in compliance with said at least one first protocol.

Correspondingly, in this particular implementation, the supply method implemented by the radio tag further includes:
a reception step of receiving a message in compliance with said at least one first protocol and including a response message from the destination entity encapsulated using said at least one second protocol; and
a de-encapsulation step of de-encapsulating the response message.

This implementation makes it possible not only to establish an uplink from the radio tag to the destination entity, but also a downlink from the destination entity to the radio tag so as to enable data to be exchanged between these two entities. Such data exchange enhances the use of radio tags in applications such as, for example, bank transactions and detecting specific events (e.g. alarms, exceeding a threshold, etc.) and for transmitting configuration data or commands to the radio tag in response to such detection, etc.

Various strategies may be envisaged for enabling the radio tag to signal to the reader that it has data for transmitting to the destination entity.

Thus, in a variant, the communications method further includes a read step for reading a predetermined memory address of the radio tags in order to determine whether the radio tags have data for transmitting to the destination entity.

In another variant, the radio tag signals to the reader that it has data for transmission by using a specific predetermined command.

In yet another variant, the supply method includes a reception step for receiving an inventory message from the reader inviting the radio tag to identify itself with the reader, a radio tag identifying itself with the reader only if it has data for transmission to the destination entity.

As mentioned above, selecting one or the other of these strategies makes it possible to reuse certain already-defined commands in prior art radio interface protocols, or on the contrary requires commands to be defined that are new compared with existing commands.

In another particular implementation, the various steps of the communications method and/or of the supply method are determined by program instructions for computers or microcontrollers.

Consequently, the invention also provides a computer program on a data medium, the program being suitable for being performed in a radio tag reader or more generally in a computer, the program including instructions adapted to performing steps of the communications method as described above.

The program may use any programming language, and it may be in the form of source code, object code, or code intermediate between source code and object code, such as in a partially compiled form, or in any other desirable form.

The invention also provides a computer readable data medium, including instructions of a computer program as mentioned above.

The data medium may be any entity or device capable of storing the program. For example, the medium may comprise storage means such as a read only memory (ROM), for example a compact disk (CD) ROM or a microelectronic circuit ROM, or indeed magnetic recording means, e.g. a floppy disk or a hard disk.

Furthermore, the data medium may be a transmissible medium such as an electrical or optical signal that can be conveyed via an electrical or optical cable, by radio, or by other means. The program of the invention may in particular be downloaded from a network of the Internet type.

Alternatively, the data medium may be an integrated circuit in which the program is incorporated, the circuit being adapted to execute or to be used in the execution of the method in question.

In a particular implementation, the various steps of the supply method are implemented by a silicon chip comprising transistors adapted to constitute logic gates of a non-programmable hard-wired logic circuit.

In another particular implementation, the various steps of the supply method are implemented by a silicon chip including a (re)programmable microcontroller and nonvolatile memories storing a computer program, the program being suitable for being performed in a radio tag, the program including instructions adapted to performing steps of the supply method as described above.

The program may use any programming language, and it may be in the form of source code, object code, or code intermediate between source code and object code, such as in a partially compiled form, or in any other desirable form.

The invention also provides a data medium readable by a microcontroller of a silicon chip and including instructions of a computer program as mentioned above.

The data medium may be any entity or device capable of storing the program. For example, the medium may comprise storage means, such as a microelectronic circuit ROM.

Furthermore, the data medium may be a transmissible medium such as an electrical or optical signal that can be conveyed via an electrical or optical cable, by radio, or by other means. The program of the invention may in particular be downloaded from a network of the Internet type.

Alternatively, the data medium may be an integrated circuit in which the program is incorporated, the circuit being adapted to execute or to be used in the execution of the method in question.

This embodiment is particularly advantageous in the context of radio tags.

The invention also provides a communications system comprising:
a destination entity;
a reader of the invention for reading passive radio tags operating in backscattering mode; and
at least one radio tag of the invention, having data for transmission to the destination entity.

The communications system of the invention benefits from the same advantages as those mentioned above for the communications method, the supply method, the reader, and the radio tag of the invention.

In other embodiments, it is also possible to envisage that the communications method, the supply method, the reader, the radio tag, and the communications system of the invention present in combination some or all of the above-mentioned characteristics.

### BRIEF DESCRIPTION OF THE DRAWINGS

Other characteristics and advantages of the present invention appear from the following description made with reference to the accompanying drawings that show an implementation having no limiting character. In the figures:

FIG. 1 shows, in diagrammatic manner, a communications system, a radio tag, and a reader in accordance with the invention in a particular embodiment;

FIGS. 2 and 3 are diagrams showing the architectures respectively of the radio tag and of the reader of FIG. 1;

FIG. 4 shows, in the form of a flowchart, the main steps of a communications method of the invention as performed by the FIG. 1 reader; and

FIG. 5 shows, in the form of a flowchart, the main steps of a supply method of the invention as performed by the FIG. 1 radio tag.

### DETAILED DESCRIPTION OF THE INVENTION

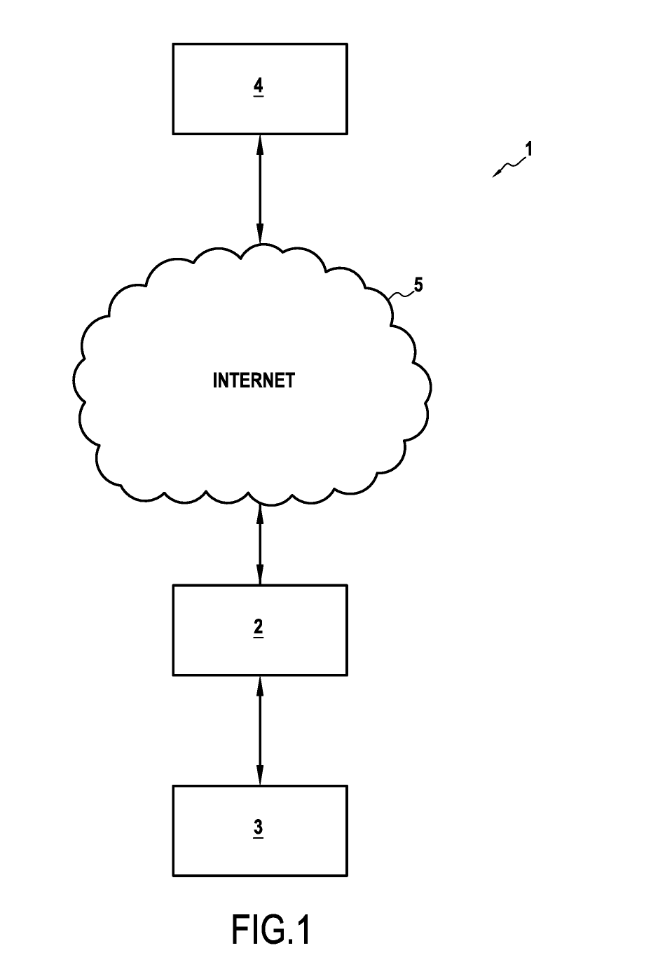

FIG. 1 shows, a particular embodiment of a communications system 1 in accordance with the invention, in its environment.

The communication system 1 comprises:
a reader 2 of the invention for reading passive radio tags;
at least one passive radio tag 3 in accordance with the invention; and
a destination entity 4 for data collected and/or processed by the radio tag 3.

No limitation is associated with the nature of the destination entity 4. In the context envisaged for applying the invention, it may thus be a software application, an information system, a server (e.g. a storage server or a secure server), or even another radio tag communicating with the radio tag 3 via the reader 2, or via a reader distinct therefrom and connected to the reader 2, etc.

By way of example, it is assumed herein that the destination entity 4 is a server hosted by an aircraft maintenance operator, the server being dedicated to monitoring the operation of the engine of the aircraft on the basis of data acquired by one or more sensors on board the engine (e.g. a pollution sensor, a temperature sensor, an acceleration sensor, etc.) and collected by the radio tag(s) 3.

For simplification purposes, it should be observed that the present example is limited to a single destination entity 4 for the data collected by the radio tag(s) 3. Nevertheless, this assumption is not itself limiting, and it is possible to envisage that the radio tag(s) 3 have data for returning to a plurality of distinct destination entities.

In the example shown in FIG. 1, the destination entity 4 is connected to the radio tag reader 2 via a telecommunications network 5, specifically in this example the public Internet. Nevertheless, these assumptions are not limiting: the destination entity 4 may thus be connected directly to the reader 2, or it is possible to consider some type of network other than the Internet (e.g. a private network).

The radio tag 3 is a passive radio tag (optionally assisted by a battery or by a local energy harvesting system), operating in a backscattering mode. As mentioned above, this type of radio tag does not include an RF transmitter, but reflects and modulates the wave coming from a reader illuminating it, so as to transmit information or data thereto using a radio communication interface of known type. In other words, passive radio tags never transmit information spontaneously, but wait to be interrogated individually by a reader situated in radio proximity, the reader coming to read one or more specific and predetermined memory addresses of the radio tag. In this example, no limitation is associated with the frequency used by the reader 2 and the radio tag 3 for communications purposes. Thus, the invention applies equally well to low frequencies (e.g. in the range 125 kilohertz (kHz) to 134.2 kHz or in the range 140 kHz to 148.5 kHz), to high frequencies (e.g. 13.56 megahertz (MHz)), or indeed ultra high frequencies (e.g. in the 860 MHz to 960 MHz frequency range).

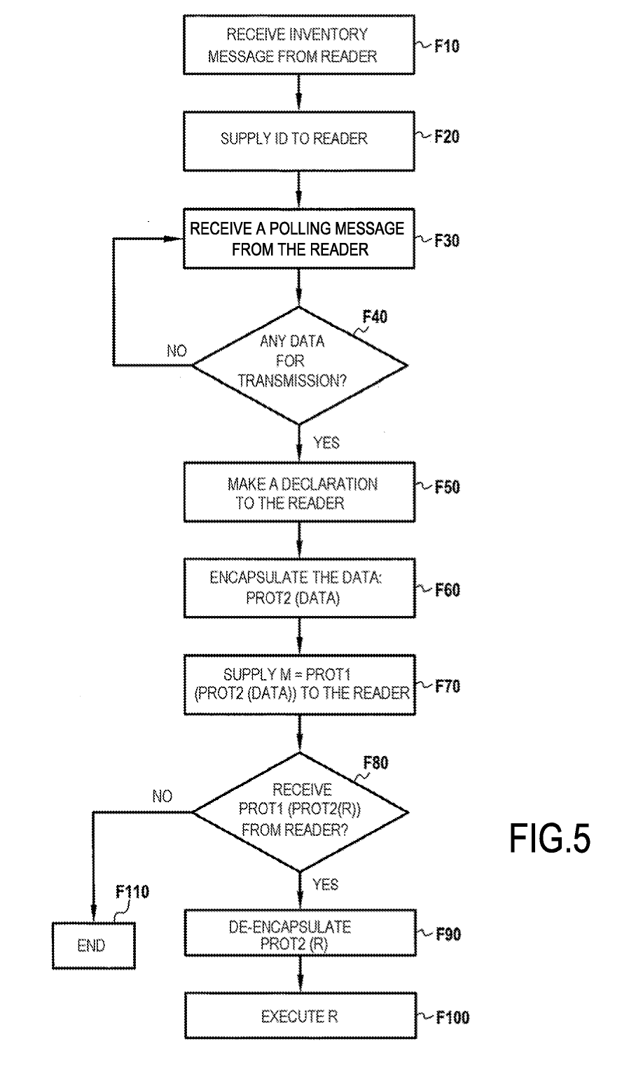

In the presently described implementation, the radio tag 3 incorporates an electronic silicon chip that in this example comprises a (re)programmable microcontroller for executing steps of a method of supplying data to the destination entity 4 via the reader 2 as described below with reference to FIG. 5.

In a variant, the radio tag 3 may incorporate an electronic silicon chip having transistors adapted to constitute logic gates of a non-programmable hard-wired logic circuit for executing steps of the supply method shown in FIG. 5.

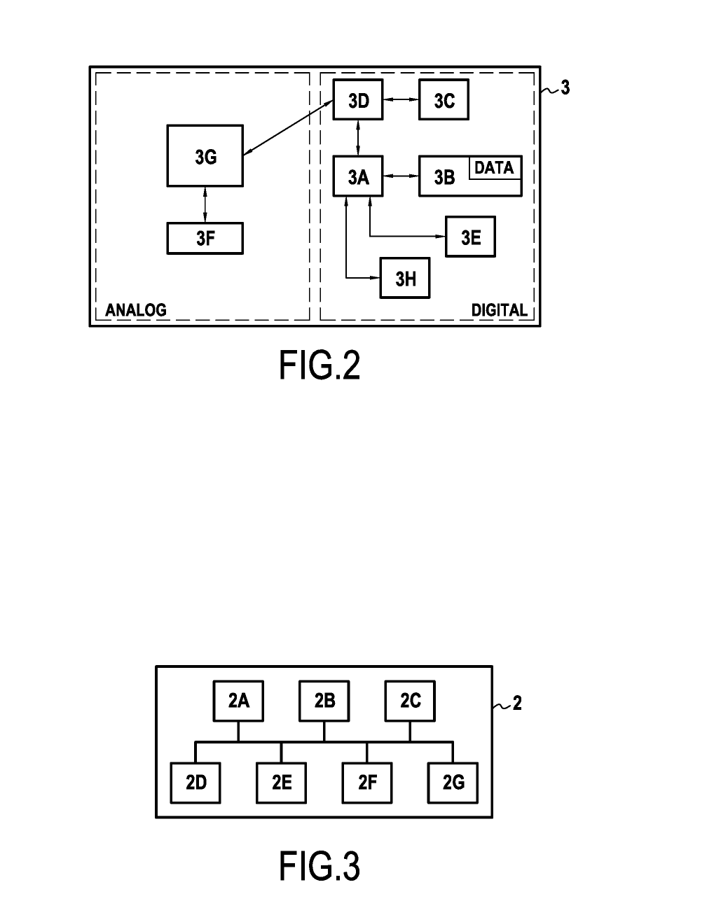

In the presently described implementation, the radio tag 3 includes advanced functions and/or applications for collecting and processing data (e.g. calculation, event generation, etc.), that are implemented by the microcontroller. An example of architecture for the radio tag 3 is shown in FIG. 2.

In this example, the radio tag 3 comprises a digital portion incorporating in particular a microcontroller 3A, nonvolatile memories 3B and 3C (the memory 3B stores the data DATA collected and processed by the radio tag 3), a module 3D implementing a radio interface using a protocol PROT1 (first protocol in the meaning of the invention), and one or more interfaces 3E e.g. with sensors (not shown) external to the radio tag 3 and enabling it to collect data. In the presently described example, the radio tag 3 also has one or more hard-wired digital interfaces (not shown in the figure), e.g. such as a serial peripheral interface (SPI). In particular, these interfaces enable the radio tag 3 to exchange information with the outside (i.e. with a device external to the tag), typically in an asynchronous mode of operation.

In the presently described example, the protocol PROT1 is an electronic product code (EPC) UHF Gen2 protocol recognised by ISO standard 18000-6c, and using the 860 MHz to 960 MHz UHF band. With reference to the known OSI communications model, this protocol defines protocol layers L1 (physical layer) and L2 (data link layer), together with high-level functions on the layer L2 such as for example read and/or write access to the memory of the radio tag. It should be observed that the invention is not limited to implementing the EPC UHF Gen2 protocol in order to define the radio interface between the radio tag 3 and the reader 2. It is possible to envisage other protocols, such as, in nonexhaustive manner, the following protocols: ISO 14443 (used for RFID passports), ISO 15693 (use in particular for credit card payment), or indeed ISO 18000-x, all of which are known.

The radio tag 3 also has an analog portion incorporating a module 3F for managing power and a module 3G for harvesting (or capturing) local energy and for RF modulation. These various elements and modules are themselves known and are not described in detail herein.

By way of example, the LeapTag™ radio tag sold by the supplier ORIDAO includes such elements and modules.

In accordance with the invention, the radio tag 3 also comprises, in its digital portion, a module 3H suitable for implementing protocols PROT2 of layers higher than the layers L1 and L2 of the radio interface defined by the module 3D (second protocols in the meaning of the invention). For example, the module 3H implements a stack of protocols PROT2 including the network layer (L3) and the transport layer (L4) of the OSI model. In a variant, the stack of protocols PROT2 may also include an application layer (L7) of the OSI model.

Thus, by way of illustration and for example, the module 3H of the radio tag 3 may implement as its protocol(s) PROT2, the IP protocol (network layer protocol) and/or the UDP/IP protocol (transport layer protocol) functioning above the IP protocol. Naturally, other protocols may be envisaged as a function of the application context of the invention, and in particular proprietary protocols or secure transport protocols such as the DTLS protocol functioning above the UDP/IP protocol.

Similarly, it is assumed that the destination entity 4 likewise implements the protocols PROT2 in order to be able to communicate with the radio tag 3 and interpret the data (and messages) sent by the tag to the entity.

As mentioned above, the radio tag reader 2 is an active device that transmits radio frequencies for activating the chips of radio tags that are within its read field (and in particular in this example the chips of the radio tag 3), i.e. tags that are in radio proximity of the reader 2, by supplying them with the energy they need in order to operate. A dialogue is then established between the reader 2 and the radio tag using the communications protocol PROT1, i.e. specifically in this example the EPC UHF Gen2 protocol.

In the presently described implementation, the reader 2 has the hardware architecture of a computer, as shown in FIG. 3. In particular, it comprises a processor 2A, a ROM 2B, a random access memory (RAM) 2C, a nonvolatile memory 2D, communications means 2E for communicating via the telecommunications network 5 with the destination entity 4 (e.g. incorporating a conventional network card), and an RFID communications module 2F implementing a radio interface with the radio tag 3 (including in particular an antenna suitable for transmitting and for receiving radiofrequency signals coming from the radio tag 3). In the presently described example, this radio interface is defined by the EPC UHF Gen2 protocol as described above.

The reader 2 also has a module 2G enabling it to route messages that are encapsulated by the protocol PROT2 and that are received from the radio tag 3 via the radio interface of the communications module 2F, or that are messages encapsulated by the protocol PROT2 and that are received from the destination entity 4 via the communications means 2E and destined for the radio tag 3. This module 2G enables the reader 2 to route the messages it receives in this way to their destinations (i.e. the entity 4 or the radio tag 3). In particular, it includes the protocols of the stack of protocols PROT2 needed for this routing protocol and/or possibly for other protocols (e.g. domain name resolution protocol, etc.).

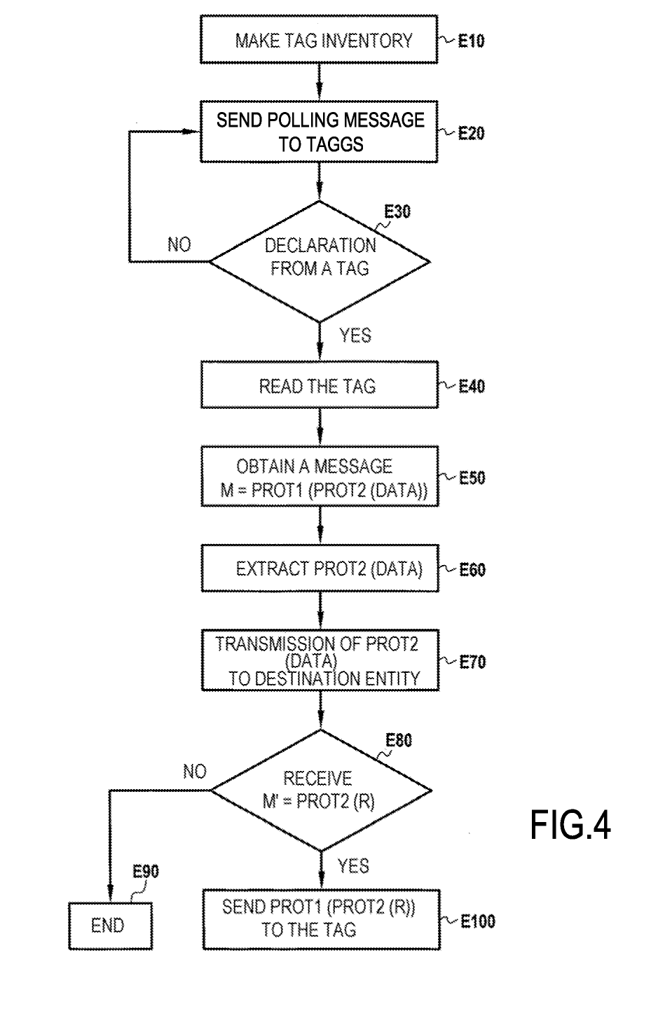

The ROM 2B of the reader 2 constitutes a data medium in accordance with the invention that is readable by the processor 2A and that stores a computer program in accordance with the invention, including instructions for executing steps of a communications method of the invention as described below with reference to FIG. 4. In corresponding manner, this computer program defines functional modules of the reader 2 suitable for performing the steps of the method (e.g. a module for sending an inventory message and/or a polling message, a module for receiving a message from a radio tag, a module for extracting data from the message, and a module for transmitting extracted data to the destination entity 4) by making use of the elements 2A-2G of the reader 2.

It should be observed that the architecture shown in FIG. 3 is not itself limiting on the invention. It is possible to envisage other architectures for the reader 2, and in particular the reader 2 may be embedded in a plurality of distinct devices. Thus, by way of example, the reader 2 may be constituted firstly by lightweight processor performing the low-level processing performed by the reader 2 (typically the radio interface using the protocol PROT1, i.e., in this example, EPC UHF Gen2), connected via a serial link (e.g. of the universal serial bus (USB) or universal asynchronous receiver transmitter (UART) type) to a computer performing the processing for the higher layers (typically the protocols of the stack of protocols PROT2 enabling the reader 2 to act as a router).

There follows a description, with reference respectively to FIGS. 4 and 5, of the main steps of a communications method and a supply method of the invention as implemented in a particular embodiment by the reader 2 and the radio tag 3 shown in FIG. 1.

It is assumed as a preliminary that the radio tag 3 has acted via its microcontroller 3A and its interface 3E with the external sensors to collect the data DATA destined for the destination entity 4 and stored in its nonvolatile memory 3B.

With reference to FIG. 4, in the presently described implementation, the reader 2 begins in conventional manner by making an inventory of the radio tags situated within its radio proximity, i.e. within the perimeter of its read distance that depends in particular on the frequency at which it transmits (step E10). For this purpose, the reader 2 sends an inventory message in compliance with the protocol PROT1 inviting radio tags situated within radio proximity to identify themselves with the reader. Such a message is itself known and it is not described in detail herein.

With reference to FIG. 5, the radio tag 3 receives the inventory message transmitted by the reader 2 over its radio interface (step F10). It then identifies itself with the reader 2 in known manner, supplying it with its numerical identifier (step F20).

In the presently described implementation, the reader 2 then uses its radio interface to send a polling message to the radio tags that have identified themselves thereto (step E20). This polling message is sent to each radio tag individually (i.e. radio tag by radio tag). It invites radio tags that have data for transmitting to the destination entity 4 (or to some other entity where appropriate) to make a declaration. In other words, it seeks to detect those radio tags that have data for transmission (test step E30). This message complies with the protocol PROT1 defining the radio interface 3D (i.e. the first protocol in the meaning of the invention).

The polling message may incorporate a specific command that is recognisable by the radio tag 3 and that invites it to make a declaration if it has data to be transmitted.

In a variant, the polling message may include a standard read command for reading a predetermined memory address of the radio tag 3 and containing an indication as to whether or not the radio tag 3 has data for transmission. Such a command is itself known, and is provided for by way of example in the protocol EPC UHF GEN. The memory address specified in the command may be identical to the memory address in which the radio tag 3 places its numerical identifier, or on the contrary it may be distinct.

In the presently described implementation, an inventory message is sent initially, followed by a polling message that is distinct from the inventory message and that is sent to those radio tags that have identified themselves with the reader 2 in response to the inventory message. In another implementation, the polling message may be incorporated in or may be the same as the inventory message. Thus, in particular, it may be the inventory message itself that is transmitted in compliance with the protocol PROT1 and that is then interpreted by the tags as an invitation to declare, where appropriate, that they have data for transmitting to the entity 4, and thus in this respect represents a polling message in the meaning of the invention. This inventory message also acting as a polling message may specify a specific memory address or may contain a specific command inviting the radio tags to make a declaration if they have data for transmission.

The radio tag 3 receives the polling message transmitted by the reader 2 (step F30).

The radio tag 3 then determines whether it has data for transmitting to the destination entity 4 (test step F40).

For this purpose, the microcontroller 3A may implement event detection functions (e.g. based on thresholds) taking account in particular of the context in which the radio tag 3 is to be found, the radio tag 3 determining that it has data for transmission to the destination entity 4 if it has detected predetermined events. Such event detections requiring data to be returned to the destination entity 4 comprise for example:
the radio tag 3 may be programmed to monitor the values acquired by external sensors, and to detect when those values exceed one or more predefined thresholds. Crossing a predefined threshold constitutes detecting an event and can trigger the event being returned to the destination entity 4;
the radio tag 3 may be programmed to analyze the vibration of a device on the basis of values acquired by one or more external sensors, and to detect the appearance of certain frequencies during such analysis. Such detection may trigger the event being returned to the destination entity 4.

Naturally, no limitation is associated with the event as such that triggers the transmission of data by the radio tag 3 to the destination entity 4. It is even possible to envisage that the radio tag 3 returns all or some of the data that it has acquired and/or processed (the event is then either the radio tag detecting acquisition or else processing all or some of the data).

In this example it is assumed that the radio tag 3 decides to transmit the data DATA stored in its nonvolatile memory 3B to the destination unit 4 (response “yes” to step F40). It thus uses a dedicated declaration message (i.e. a specific command) that is transmitted in this example in compliance with the protocol PROT1, to declare to the reader 2 that it has data for transmission (step F50).

In a variant, this declaration is made in response to the polling message, by positioning information in a specific address of the nonvolatile memory 3C identified in the polling message to the effect that the radio tag has data for transmission to the destination entity 4. In other words, in this variant, the radio tag 3 makes dynamic use of (i.e. updates) the memory address if it has data for transmission to the destination entity 4. By interrogating the radio tag 3 via the polling message, the reader 2 thus reads this specific memory address of the radio tags in order to identify those tags that have data for transmission.

In yet another variant, when the polling message is incorporated in or coincides with the inventory message, this declaration may be made in response to the inventory message, e.g. by placing information in a specific address of the nonvolatile memory 3C identified in the inventory message to the effect that the radio tag has data for transmission to the destination entity 4. By interrogating the radio tag 3, the reader 2 thus reads this specific memory address of the radio tags in order to identify those tags that have data for transmission.

In yet another variant, it is possible to envisage that only those radio tags that have data for transmission respond to the polling message and/or to the inventory message when it incorporates the polling message or is the same as the polling message.

Which one of these implementation variants is selected may depend on whether or not it is desired to reuse (and adapt where appropriate) functions that already exist in the protocol PROT1.

The declaration made by the radio tag 3 is received by the receiver 2 (response “yes” to test step E30). If no radio tag declares to the reader 2 that it has data for transmission (response no to test step E30), then a new polling message is sent subsequently to the radio tags using the protocol PROT1 (return to step E20). In the presently described implementation, such a polling message is transmitted periodically by the reader 2 in order to identify without delay any radio tag that has data for transmission to the entity 4.

On receiving a declaration from a radio tag, the reader 2 then interrogates the tag, e.g. using a request specifying the memory address in which the data DATA for transmission is stored or using a predetermined specific command (step E40).

The radio tag 3 responds to this interrogation by encapsulating the data DATA that it seeks to transmit to the entity 4 in a frame T (or more generally in a message) T=PROT2(DATA) in compliance with the transport and/or network protocol(s) PROT2 implemented by the module 3H (step F60). For example, if the module 3H implements an IP protocol or a UDP/IP protocol, then the data DATA is encapsulated using that protocol. Furthermore, other protocols may be used above UDP/IP, in particular for the purpose of making exchanges between the radio tag 3 and the entity 4 secure. Thus, by way of example, it is possible to envisage also using the data transport layer Security (DTLS) protocol above the UDP/IP protocol in order to encapsulate the data DATA. This protocol comes within the stack of protocols PROT2.

Thereafter, the encapsulated data T=PROT2(DATA) is then supplied (i.e. sent) to the reader 2 in a message M=PROT1(T) in compliance with the protocol PROT1 implemented by the module 3D and defining the radio interface between the reader 2 and the radio tag 3 (step F70).

On receiving a message M (step E50), the reader 2 extracts the encapsulated data T=PROT2(DATA) destined for the destination entity 4 (step E60).

It then transmits this data encapsulated using the protocol PROT2 to the destination entity 4 (step E70). The reader 2 thus acts merely as a router of the data DATA received from the radio tag 3, sending it to the entity 4 by means of its module 2G. The reachability address of the entity 4 (i.e. in this example its IP address on the network 5) that is to receive the data encapsulated using the protocol(s) PROT2 transmitted by the radio tag 3 can be deduced, as a function of the routing mode that is envisaged and permitted by the protocol(s) PROT2 (e.g. routing as a function of the destination address or of the source address), in particular from a message header in compliance with the protocol(s) PROT2 in known manner (e.g. destination IP address specified directly in the header by the radio tag 3 or obtained by resolving a domain name). Naturally, it is possible to use other means for obtaining this reachability address, as a function of the protocols PROT2 under consideration. This step does not present any specific difficulty for the person skilled in the art, and it is not described in greater detail herein. The data DATA encapsulated in the protocol PROT2 is received by the entity 4, and is then de-encapsulated thereby. For this purpose, it is assumed that the entity 4 also has a stack of protocols PROT2 enabling it to interpret the message sent by the radio tag 3. The entity 4 processes the data DATA as received in this way from the radio tag 3, in compliance with its programming.

In the presently described implementation, after receiving and processing the data DATA, the entity 4 can send a response R to the radio tag 3. This response R may merely be an acknowledgement of receipt or it may be a command sent to the radio tag 3. By way of example, such a command seeks to modify the configuration of the radio tag 3, e.g. by adjusting the thresholds used by the radio tag for detecting events on the basis of the data it acquires from sensors, etc.

The response R is sent by the entity 4 to the reader 2 so that it transfers it to the radio tag 3. This response R is encapsulated in a message by the entity 4 in compliance with the protocol PROT2 (message T′=PROT2(R)).

On receiving a message T′=PROT2(R) (response “yes” in step E80), the reader 2 identifies the destination radio tag 3 for the message (e.g. indicated in a header of the message PROT2(R)), and then encapsulates the message T′=PROT2(R) in a message in compliance with the protocol PROT1 in order to transmit it over a radio interface (step E100).

The message M′=PROT1(PROT2(R)) is transmitted by the reader 2 to the radio tag 3. On receiving this message via a radio interface (response “yes” in step F80), the radio tag 3D de-encapsulates the response R (step F90). Where appropriate, it executes the command contained in the response R (step F100).

As mentioned above, the invention thus provides the possibility for passive radio tags to use the novel messages it introduces (e.g. the polling message, encapsulated data and response messages) to act proactively to push the data they have collected to destination entities such as servers or applications.

Various utilisation contexts can be envisaged for the invention, and two examples are given below by way of nonlimiting illustrations.

By way of example, a first field of use lies in monitoring the operation of a device such as an aeroengine, by means of an entity 4 to be found with a maintenance operator of the aircraft. The radio tag 3 can then include in the microcontroller 3A an application for monitoring a sensor arranged in the motor, storing data locally in the memory 3B, and processing the data in order to extract pertinent events therefrom. By way of example, such events include:
for a pollution sensor, an alarm that may be stored when the level of pollution measured by the sensor is greater than a programmed threshold;
for a temperature sensor and an accelerometer, storage or operating conditions can be monitored, etc.

Under all circumstances, preferably only pertinent events (e.g. exceeding a threshold) are stored and reported to the destination entity 4. Most of the time, the radio tag 3 therefore has no data to report to the destination entity 4: it is assumed in this example that when it has no data for transmitting to the destination entity 4, it does not respond to the inventory message transmitted by the reader nor to the polling message sent periodically.

In a variant, and as mentioned above, it may respond to either of these messages by declaring that it has no data to transmit to the destination entity 4.

When an event is detected by the radio tag 3, it is assumed in this example that the radio tag 3 responds to the polling message from the reader 2 and pushes the event (the data DATA thus corresponds to the detected events) towards the destination entity 4 in accordance with the invention (i.e. by encapsulating it in a message T in compliance with the protocol PROT2 sent to the reader 2 over the radio interface in compliance with the protocol PROT1 in the form of a message M). The radio tag 3 thus speaks the same language as the destination entity 4 (e.g. UDP/IP with DTLS), such that the radio tag 3 and the entity 4 can transfer data mutually in secure manner. Specifically, the reader 2 and where appropriate, intermediate routers between the reader 2 and the entity 4, has/have knowledge only of the destination of the message that encapsulates the data transmitted by the radio tag and/or the entity 4, but not of its content.

The entity 4 can then merely acknowledge receipt of the event or it can respond thereto via the reader by pushing configuration data to the radio tag encapsulated using the protocol PROT2. In turn, the reader encapsulates the response received from the destination entity 4 in a message in compliance with the protocol PROT1. Examples of configuration data include a monitoring period or an event detection threshold.

A second field of use relates to the field of banking, and in particular processing transactions between two actors A and B. The actors A and B may equally well be users, terminals, a terminal and a server, etc.

By way of illustration, it is assumed that A and B are two users seeking to carry out a bank transaction via their respective terminals. The destination entity 4 is a secure central server managing transactions, and acting as an intermediary between the actor A and the actor B. Each actor participating in the transaction has a corresponding radio tag embedded in a terminal. By way of example, the radio tag is a UHF radio tag including a secure element and linked to input/output peripherals via a wired or wireless digital interface, such as for example a biometric sensor (fingerprint sensor), a keyboard enabling information to be input in association with the transaction, or indeed a screen.

When a transaction is initiated by the actor A, the radio tag 3 identifies the actor by means of the biometric sensor, after which the actor can input transaction information via the keyboard. This information is collected by the microcontroller 3A of the radio tag 3, which then pushes the information in accordance with the invention via a reader 2 to the secure central server 4. More specifically, the radio tag 3 response to a polling message sent by the reader by declaring to the reader 2 that it has data for transmitting to the central server 4. Thereafter it sends the transaction information in a message M to the reader 2 for forwarding to the secure central server 4.

The message M complies with the protocol PROT1 and it contains the transaction information encapsulated in one or more protocols PROT2. In this example, the protocol(s) PROT2 include(s) at least one asymmetric cryptography protocol and associated certificates in order to secure the exchanges between the actor A and the central server 4.

On receiving the message M, the reader 2 extracts the transaction information as encapsulated using the protocol PROT2 and forwards it to the central server 4. The central server 4 authenticates the transaction and transmits it to the actor B via a second reader 2 and B's radio tag 3, in accordance with the invention.

The exchanges set up between the radio tags of the actors A and B via the central server 4 and the radio tag readers 2 for authenticating and processing the transaction can then advantageously be implemented in accordance with the invention. The information exchanged between the actors A and B is then secure.

It should be observed that in this example, the transaction is authenticated by the server on line. In a variant, it is possible to envisage that the radio tags of the actors A and B exchange data about the transaction in accordance with the invention by means of their respective readers or a single reader if both of them are connected to the same reader. In other words, in this variant, the entity that is the destination for data pushed by one of the radio tags is the other radio tag. Once the radio tags of both actors are in agreement about the details of the transaction, the details are sent in a synchronous manner to the central secure server for verification of the transaction and for approval. In other words, the destination entity 4 may change depending on the context.

1. A communications method for performing by a reader of passive radio tags operating in backscattering mode, the reader and the radio tags communicating via at least one radio interface first protocol, the radio interface including at least one protocol layer, said communications method comprising:
a sending step of sending to the radio tags a polling message in compliance with said at least one first protocol, the polling message inviting the radio tags that have data for transmitting to a destination entity to make a declaration;
after at least one radio tag has made a declaration, a reception step of receiving a message in compliance with said at least one first protocol coming from said radio tag, the message including data destined for the destination entity and encapsulated using at least one second protocol of a protocol layer higher than said at least one radio interface protocol layer;
an extraction step of extracting from the message the data that has been encapsulated using said at least one second protocol; and
a transmission step of transmitting the data encapsulated using said at least one second protocol to the destination entity.

2. A communications method according to claim 1, including an inventory-taking step of sending an inventory message inviting the radio tags situated in a radio proximity of the reader to identify themselves with the reader.

3. A communications method according to claim 2, wherein the polling message is included in the inventory message or is the inventory message.

4. A communications method according to claim 1, wherein the step of sending the polling message is repeated periodically.

5. A communications method according to claim 1, further comprising:
a reception step of receiving from the destination entity a response message destined for the passive radio tag and encapsulated using said at least one second protocol; and
a transmission step of transmitting the response message encapsulated using said at least one second protocol to the passive radio tag in a message in compliance with said at least one first protocol.

6. A communications method according to claim 1, further including a read step for reading a predetermined memory address of said radio tags in order to determine whether said radio tags have data for transmitting to the destination entity.

7. A supply method for supplying a radio tag reader with data destined for a destination entity, said supply method of being for implementation by a passive radio tag operating in backscattering mode, the radio tag being suitable for communicating with the reader via at least one radio interface first protocol, the radio interface including at least one protocol layer, said method comprising:
a reception step of receiving a polling message from the reader, in compliance with said at least one first protocol and inviting the radio tag to declare to the reader whether it has data for transmitting to the destination entity;
if the radio tag makes a declaration to the reader that it has data for transmitting to the destination entity:
an encapsulating step of encapsulating the data using at least one second protocol of a protocol layer higher than said at least one radio interface protocol layer; and
a supply step (F70) of supplying the reader with a message in compliance with said at least one first protocol and including the data encapsulated using said at least one second protocol.

8. A supply method according to claim 7, further comprising:
a reception step of receiving a message in compliance with said at least one first protocol and including a response message to the destination entity encapsulated using said at least one second protocol; and
a de-encapsulation step of de-encapsulating the response message.

9. A supply method according to claim 7, including a reception step for receiving an inventory message from the reader inviting the radio tag to identify itself with the reader, the radio tag identifying itself with the reader only if it has data for transmission to the destination entity.

10. A method according to claim 1 wherein the higher protocol layer is a transport, network, or application layer of an OSI communications model.

11. A method according to claim 10, wherein said at least one second protocol comprises an IP network layer protocol and/or at least one transport layer protocol operating above the IP protocol.

12. A reader of passive radio tags operating in backscattering mode, said reader and said radio tags communicating via at least one radio interface first protocol, the radio interface including at least one protocol layer, said reader comprising:
a sending module for sending to the radio tags a polling message in compliance with said at least one first protocol, the polling message inviting the radio tags that have data for transmitting to a destination entity to make a declaration;
a module that is activated after at least one radio tag has made a declaration, for receiving a message in compliance with said at least one first protocol coming from said radio tag, the message including data destined for the destination entity and encapsulated using at least one second protocol of a protocol layer higher than said at least one radio interface protocol layer;
a module for extracting from the message the data that has been encapsulated using said at least one second protocol; and
a module for transmitting the data encapsulated using said at least one second protocol to the destination entity.

13. An invention selected from the group consisting of:
(i) a passive radio tag operating in backscattering mode, suitable for communicating with a radio tag reader via at least one radio interface first protocol, the radio interface including at least one protocol layer, said radio tag comprising:
a module for receiving a polling message from the reader, in compliance with said at least one first protocol and inviting the radio tag to declare to the reader whether it has data for transmitting to the destination entity;
a module that is activated if the radio tag declares to the reader that it has data for transmitting to the destination entity, for encapsulating the data using at least one second protocol of a protocol layer higher than said at least one radio interface protocol layer; and
a module for supplying the reader with a message in compliance with said at least one first protocol and including the data encapsulated using said at least one second protocol;
(ii) a communications system comprising:
a destination entity;
a reader for reading passive radio tags operating in backscattering mode, said reader and radio tags communicating via at least one radio interface first protocol, the radio interface including at least one protocol layer, said reader comprising:
a sending module for sending to the radio tags a polling message in compliance with said at least one first protocol, the polling message inviting the radio tags that have data for transmitting to a destination entity to make a declaration;
a module that is activated after at least one radio tag has made a declaration, for receiving a message in compliance with said at least one first protocol coming from said radio tag, the message including data destined for the destination entity and encapsulated using at least one second protocol of a protocol layer higher than said at least one radio interface protocol layer;
a module for extracting from the message the data that has been encapsulated using said at least one second protocol; and
a module for transmitting the data encapsulated using said at least one second protocol to the destination entity; and
at least one radio tag comprising a passive radio tag operating in backscattering mode, suitable for communicating with a radio tag reader via at least one radio interface first protocol, the radio interface including at least one protocol layer, said radio tag comprising:
a module for receiving a polling message from the reader, in compliance with said at least one first protocol and inviting the radio tag to declare to the reader whether it has data for transmitting to the destination entity;
a module that is activated if the radio tag declares to the reader that it has data for transmitting to the destination entity, for encapsulating the data using at least one second protocol of a protocol layer higher than said at least one radio interface protocol layer; and
a module for supplying the reader with a message in compliance with said at least one first protocol and including the data encapsulated using said at least one second protocol, having data for transmission to the destination entity;
(iii) a computer program including instructions for executing steps of
a communications method for performing by a reader of passive radio tags-operating in backscattering mode, the reader and the radio tags communicating via at least one radio interface first protocol, the radio interface including at least one protocol layer, said communications method comprising:
a sending step of sending to the radio tags a polling message in compliance with said at least one first protocol, the polling message inviting the radio tags that have data for transmitting to a destination entity to make a declaration;
after at least one radio tag has made a declaration, a reception step of receiving a message in compliance with said at least one first protocol coming from said radio tag, the message including data destined for the destination entity and encapsulated using at least one second protocol of a protocol layer higher than said at least one radio interface protocol layer;
an extraction step of extracting from the message the data that has been encapsulated using said at least one second protocol; and
a transmission step of transmitting the data encapsulated using said at least one second protocol to the destination entity;
(iv) a supply method for supplying a radio tag reader with data destined for a destination entity, said supply method of being for implementation by a passive radio tag operating in backscattering mode, the radio tag being suitable for communicating with the reader via at least one radio interface first protocol, the radio interface including at least one protocol layer, said method comprising:
a reception step of receiving a polling message from the reader, in compliance with said at least one first protocol and inviting the radio tag to declare to the reader whether it has data for transmitting to the destination entity;
if the radio tag makes a declaration to the reader that it has data for transmitting to the destination entity:
an encapsulating step of encapsulating the data using at least one second protocol of a protocol layer higher than said at least one radio interface protocol layer; and
a supply step of supplying the reader with a message in compliance with said at least one first protocol and including the data encapsulated using said at least one second protocol, when said program is executed by a computer by a microcontroller;
(v) a computer- or microcontroller-readable data medium storing a computer program including instructions for executing steps of
(a) a communications method for performing by a reader of passive radio tags operating in backscattering mode, the reader and the radio tags communicating via at least one radio interface first protocol, the radio interface including at least one protocol layer, said communications method comprising:
a sending step of sending to the radio tags a polling message in compliance with said at least one first protocol, the polling message inviting the radio tags that have data for transmitting to a destination entity to make a declaration;
after at least one radio tag has made a declaration, a reception step of receiving a message in compliance with said at least one first protocol coming from said radio tag, the message including data destined for the destination entity and encapsulated using at least one second protocol of a protocol layer higher than said at least one radio interface protocol layer;
an extraction step of extracting from the message the data that has been encapsulated using said at least one second protocol; and
a transmission step of transmitting the data encapsulated using said at least one second protocol to the destination entity, or
(b) a supply method for supplying a radio tag reader with data destined for a destination entity, said supply method of being for implementation by a passive radio tag operating in backscattering mode, the radio tag being suitable for communicating with the reader via at least one radio interface first protocol, the radio interface including at least one protocol layer, said method comprising:
a reception step of receiving a polling message from the reader, in compliance with said at least one first protocol and inviting the radio tag to declare to the reader whether it has data for transmitting to the destination entity;
if the radio tag makes a declaration to the reader that it has data for transmitting to the destination entity:
an encapsulating step of encapsulating the data using at least one second protocol of a protocol layer higher than said at least one radio interface protocol layer; and
a supply step of supplying the reader with a message in compliance with said at least one first protocol and including the data encapsulated using said at least one second protocol.

14. An invention according to claim 13, wherein said inventions is the communications system comprising:
a destination entity;
a reader for reading passive radio tags operating in backscattering mode, said reader comprising
A reader of passive radio tags operating in backscattering mode, said reader and said radio tags communicating via at least one radio interface first protocol, the radio interface including at least one protocol layer, said reader comprising:
a sending module for sending to the radio tags a polling message in compliance with said at least one first protocol, the polling message inviting the radio tags that have data for transmitting to a destination entity to make a declaration;
a module that is activated after at least one radio tag has made a declaration, for receiving a message in compliance with said at least one first protocol coming from said radio tag, the message including data destined for the destination entity and encapsulated using at least one second protocol of a protocol layer higher than said at least one radio interface protocol layer;
a module for extracting from the message the data that has been encapsulated using said at least one second protocol; and
a module for transmitting the data encapsulated using said at least one second protocol to the destination entity; and
at least one radio tag comprising a passive radio tag operating in backscattering mode, suitable for communicating with a radio tag reader via at least one radio interface first protocol, the radio interface including at least one protocol layer, said radio tag comprising:
a module for receiving a polling message from the reader, in compliance with said at least one first protocol and inviting the radio tag to declare to the reader whether it has data for transmitting to the destination entity;
a module that is activated if the radio tag declares to the reader that it has data for transmitting to the destination entity, for encapsulating the data using at least one second protocol of a protocol layer higher than said at least one radio interface protocol layer; and
a module for supplying the reader with a message in compliance with said at least one first protocol and including the data encapsulated using said at least one second protocol, having data for transmission to the destination entity.

15. An invention according to claim 13, wherein the invention is
(iii) the computer program including instructions for executing steps of
a communications method for performing by a reader of passive radio tags-operating in backscattering mode, the reader and the radio tags communicating via at least one radio interface first protocol, the radio interface including at least one protocol layer, said communications method comprising:
a sending step of sending to the radio tags a polling message in compliance with said at least one first protocol, the polling message inviting the radio tags that have data for transmitting to a destination entity to make a declaration;
after at least one radio tag has made a declaration, a reception step of receiving a message in compliance with said at least one first protocol coming from said radio tag, the message including data destined for the destination entity and encapsulated using at least one second protocol of a protocol layer higher than said at least one radio interface protocol layer;
an extraction step of extracting from the message the data that has been encapsulated using said at least one second protocol; and
a transmission step of transmitting the data encapsulated using said at least one second protocol to the destination entity, or
(iv) a supply method for supplying a radio tag reader with data destined for a destination entity, said supply method of being for implementation by a passive radio tag operating in backscattering mode, the radio tag being suitable for communicating with the reader via at least one radio interface first protocol, the radio interface including at least one protocol layer, said method comprising:
a reception step of receiving a polling message from the reader, in compliance with said at least one first protocol and inviting the radio tag to declare to the reader whether it has data for transmitting to the destination entity;
if the radio tag makes a declaration to the reader that it has data for transmitting to the destination entity:
an encapsulating step of encapsulating the data using at least one second protocol of a protocol layer higher than said at least one radio interface protocol layer; and
a supply step (F70) of supplying the reader with a message in compliance with said at least one first protocol and including the data encapsulated using said at least one second protocol,
when said program is executed by a computer by a microcontroller.

16. An invention according to claim 13, wherein the invention is (v) the computer- or microcontroller-readable data medium storing a computer program including instructions for executing steps of
(a) the communications method for performing by a reader of passive radio tags operating in backscattering mode, the reader and the radio tags communicating via at least one radio interface first protocol, the radio interface including at least one protocol layer, said communications method comprising:
a sending step of sending to the radio tags a polling message in compliance with said at least one first protocol, the polling message inviting the radio tags that have data for transmitting to a destination entity to make a declaration;
after at least one radio tag has made a declaration, a reception step of receiving a message in compliance with said at least one first protocol coming from said radio tag, the message including data destined for the destination entity and encapsulated using at least one second protocol of a protocol layer higher than said at least one radio interface protocol layer;
an extraction step of extracting from the message the data that has been encapsulated using said at least one second protocol; and
a transmission step of transmitting the data encapsulated using said at least one second protocol to the destination entity, or
(b) the supply method for supplying a radio tag reader with data destined for a destination entity, said supply method of being for implementation by a passive radio tag operating in backscattering mode, the radio tag being suitable for communicating with the reader via at least one radio interface first protocol, the radio interface including at least one protocol layer, said method comprising:
a reception step of receiving a polling message from the reader, in compliance with said at least one first protocol and inviting the radio tag to declare to the reader whether it has data for transmitting to the destination entity;
if the radio tag makes a declaration to the reader that it has data for transmitting to the destination entity:
an encapsulating step of encapsulating the data using at least one second protocol of a protocol layer higher than said at least one radio interface protocol layer; and
a supply step of supplying the reader with a message in compliance with said at least one first protocol and including the data encapsulated using said at least one second protocol.
